(19) United States
(12) Patent Application Publication
(10) Pub. No.: US 2006/0109397 A1
(43) Pub. Date: May 25, 2006

(54) Organic light emitting diode backlight inside LCD

(75) Inventor: Munisamy Anandan, Del Valle, TX (US)

Correspondence Address: Dr. M. Anandan, 13009 Thome Valley Dr., Del Valle, TX, 78617, US

(73) Assignee: Organic Lighting Technologies LLC, Austin, TX (US)

(21) Appl. No.: 11/267,972

(22) Filed: Nov. 7, 2005

Related U.S. Application Data
(60) Provisional application No. 60/631,040, filed on Nov. 24, 2004.

(51) Int. Cl. G02F 1/1335

(52) U.S. Cl. 349/69

(57) ABSTRACT

A planar organic light emitting diode (OLED) light source is processed on one of the substrates of a liquid crystal display (LCD) and sealed pin-hole free such that LCD processes, including internal polarizer, can be carried out on OLED without affecting the integrity of OLED and LCD. Both devices are held in alignment and hermetaically sealed between two substrates thus forming an integrated device and on application of suitable voltages to these devices OLED generates light and efficiently couples the light to LCD to function efficiently as a full color display.

### CROSS REFERENCE TO RELATED APPLICATION

Benefit of Provisional patent Application No. 60/631,040 filed Nov. 24, 2004
U.S. patent application # 20040170861—Culligan Sean et.al—“Organic Light Emitting Diode for production of polarized light”
U.S. patent application # 20050007517 A1—Munisamy Anandan—“Organic Light Emitting Diode Backlight Integrated LCD”
U.S. patent application Publication # US2003/0063231 A1—Yuan-Tung Dai et.al—“LCD panel integrated with OLED”.

### OTHER PUBLICATIONS

SID'04 Digest—Book I, p. 695 Si Nitride passivation layer, Ar plasma assisted<120 C 30 A/sec, “A thin film encapsulation stack for PLED and OLED displays” F. J. H. Van Assche et.al
SID'04 Digest—p. 1170-1173“Current Status and future prospect of in-cell polarizer technology”—Y. Ukai et.al
SID'04 Digest—p. 1384-1387—“Thin film encapsulation-silicon nitride-silicon oxide-silicon nitride-silicon oxide-silicon nitride (NONON)”—H. Lifka et.al—plasma enhanced CVD.
Balu Pathangey and Raj Solanki—“Atomic layer deposition for nanoscale thin film coatings”—Vacuum Technology & Coating, May 2000.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

Liquid Crystal Displays (LCDs) invariably employ a backlight source for reading the information on the display screen. The efficiency of the display system is a primary consideration for battery powered display systems like the ones used in digital cameras, cell phones, personal digital assistants (PDAs), lap tops and so on. In conventional display systems, the backlight is a separate device and the LCD is a separate device. The light that is coupled to LCD from backlight device undergoes losses through optical elements like the light guide, diffuser sheet and reflectors. In fact only 50-60% of the light is transmitted to LCD. In order to increase the coupling efficiency the optical elements are redesigned and molded in to one single piece. Further, in manufacturing, the assembly cost is high to assemble all the optical components with light sources like Light Emitting Diodes (LEDs) and fluorescent lamps (FLs). If flat light sources are employed, they still require a diffuser sheet and prism sheets. The present invention dispenses with the need for all these, simplifying the assembly and decreasing the manufacturing cost.

Prior inventions dealt with integrating Organic Light Emitting Diode (OLED) backlight to LCD through the substrate integration of OLED and LCD. For example one prior invention (U.S. patent application # 20050007517 A1—Munisamy Anandan—“Organic Light Emitting Diode Backlight Integrated LCD”) described the use of three substrates for integrating OLED backlight to LCD. In this invention, one substrate is shared by OLED and LCD and two hermetic seals were employed. The light from OLED needs to pass through the shared substrate of LCD and hence the coupling of light from OLED to LCD was not greatly enhanced but had better coupling than conventional two discrete OLED and LCD assembly. In another invention by Yuan-Tung Dai et.al (U.S. patent application Publication # US2003/0063231 A1—Yuan-Tung Dai et.al—“LCD panel integrated with OLED”) described red, blue and green OLED pixels fabricated on the upper portion of LCD substrate inside LCD. One major drawback of this invention is that the device can not work because OLED is sensitive to moisture and other chemicals inside LCD and needs to be sealed ‘pin-hole free’ prior to any subsequent process on OLEDs. The invention did not have any such pin-hole free sealing layer over OLED. Another drawback of this invention is the polarizing layer obtained through evaporation on OLED will not work because no polarizer through evaporation process can function as polarizer for LCD. A third drawback is the complexity of the structure. If red, blue and green OLEDs can be formed as pixels, there is no need for LCD to be built on them because OLED can itself be a light emitting display. A careful examination of this invention will distinctly reveal that the invention can never work.

Unlike the prior inventions the current invention integrates OLED in the form of sheet source of light inside LCD through correct processes to preserve the integrity of the functioning of OLED and LCD. The device is simple in its structure and couples the light from OLED efficiently in to LCD.

### BRIEF SUMMARY OF THE INVENTION

According to the present invention, a planar OLED is processed inside LCD, with OLED functioning as a continuous sheet of light source to backlight LCD. To accomplish this, the top surface of the bottom substrate of LCD is processed with OLED followed by a passivation layer which is a key layer whose process technique plays a vital role for this invention to work. Following the passivation layer is a transparent conductive layer, such as Indium Tin Oxide (ITO) followed by silicon dioxide (SiO₂) layer. Over SiO₂ layer is coated the internal polarizing layer of thin crystal film TCF-N015 made Optiva Inc. A plyimide layer, which serves as alignment layer for liquid crystal, is coated over TCF-N015. The bottom surface of top substrate of LCD contains color filter, flanked by a black matrix layer, over which is coated a passivation layer followed by ITO connected to thin film transistor (TFT). A thin film of SiO₂ is formed over ITO layer followed by TCF-N015 layer. A polyimide film over TCF-N015 serves as alignment layer for liquid crystal molecules. Between top and bottom substrate is sandwiched a thin liquid crystal film.

It is an object of this invention to provide an internal backlight to LCD for better light coupling efficiency and thus maximize the optical efficiency of LCD.

It is another object of this invention to integrate OLED backlight inside LCD making use of only two substrates and thus obtain a single compact unit that contains both LCD and backlight thus reduce the manufacturing cost.

It is yet another object of this invention to provide a ‘pin-hole free’ passivation layer over OLED to preserve its integrity of operation and ease of introduction of ‘internal polarizer’, ITO and liquid crystal aligning layer for successful functioning of the integrated device.

### BRIEF DESCRIPTION OF THE DRAWINGS

FIG. 1 is an isometric view of traditional backlight for LCD employing optical components according to one prior art.

FIG. 2 is an isometric view of OLED integrated to LCD according to another prior art.

FIG. 3A is the cross section of OLED backlight inside LCD with active matrix TFTs at the top substrate of LCD, according to present invention.

FIG. 3B is the cross section of OLED device inside FIG. 3A

FIG. 4 is the cross section of another embodiment of OLED backlight inside a passive matrix LCD.

### DETAILED DESCRIPTION

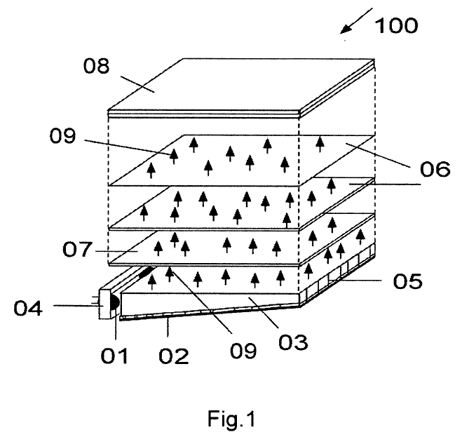

FIG. 1 shows the isometric view 100 of the traditional backlight for LCD employing optical components according to a prior art. The light source 01 is either Light Emitting Diode (LED) or Cold Cathode Fluorescent Lamp (CCFL). A reflector 04 is placed behind the light source 01 to reflect the light forward to a light guide 03 which has a patterned reflector 02 to send uniform sheet of reflected light 09 towards the back surface of LCD 08. A reflector 05 at far end of light guide 03 prevents light loss in the lateral direction. A diffuser sheet 07 above the wedge light guide makes the light uniform and the two prism sheets 06 over the diffuser sheet 07 collimates the light in to the useful viewing angle of LCD 08.

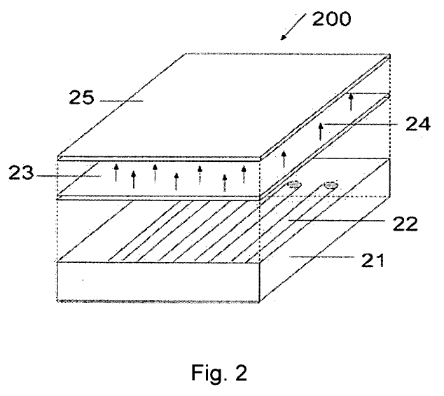

FIG. 2 shows the isometric view 200 of a direct backlight according to another prior art. The backlight box 21 contains linear fluorescent lamps 22 and a diffuser 23 assembled over the fluorescent lamps 22. The diffused light 24 uniformly backlights the LCD 25. For the sake of simplicity prism sheets are not shown in FIG. 2.

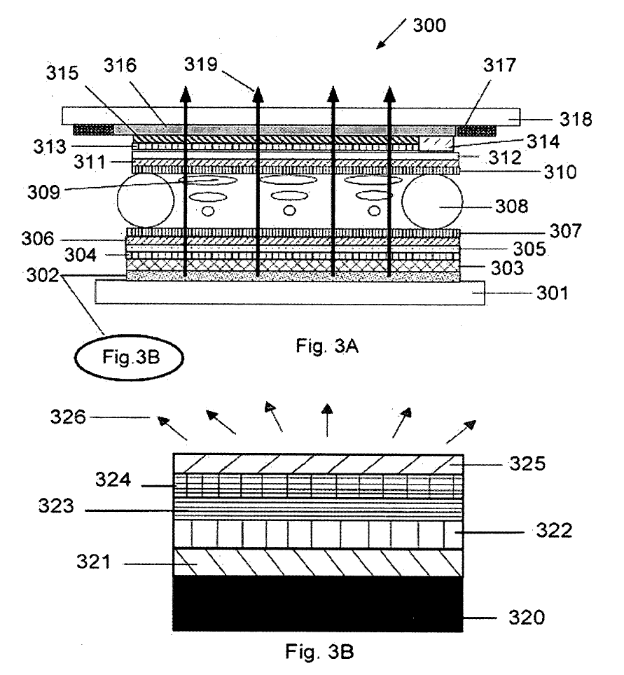

FIG. 3A illustrates the present invention through the cross section 300, for a single pixel configuration, comprising stack of layers starting from OLED up to the top substrate of LCD. Bottom substrate 301 of LCD contains OLED 302 whose layer details are given in FIG. 3B. OLED device 302 is sealed by a ‘pin-hole free’ passivation’ layer 303. This layer is the most critical layer for functioning of the structure of the present invention. The thickness of this layer is in the range of 100 nm to 500 nm. The ‘passivation’ layer, 303 on OLED to protect OLED from all subsequent processing of the bottom substrate of LCD, can be deposited through many techniques and methods. The most critical nature of the process is the low temperature (<130 C) aspect. Method (1): to employ ‘Atomic Layer Deposition’ (ALD) of thin films of SiO₂ , or Al₂O₃, or TiO₂, or Ta₂O₅, or Y₂O₃, or HfO₂, or Nb₂O₅, or MgO, or SiNx, or AlN in single layer or alternate layers of two films of different materials. Since this ‘passivation’ layer is critical for the operation of OLED, the porosity and the stress of the resulting film is very important. An illustration of forming a ‘passivation’ layer of TiO₂ through ALD process is as follows: The substrate carrying OLED, with ITO layer on top of OLED, is loaded inside an ALD chamber. During transport of OLED substrate to the ALD chamber it is important that no exposure of OLED processed substrate to ambient air takes place. The precursors for TiO₂ are injected in to the deposition chamber. The precursors for deposition are: (1) Titanium tetrachloride and (2) Ozone. The temperature of the chamber is set around 100° C. Report has appeared on the formation of TiO₂ even at room temperature through ALD process The chemical reaction that takes place at this temperature is:
TiCl₄+O₃→2TiO₂+2ClO_{2↑}
2ClO₂ is flushed out of the chamber by a pulse of N₂ gas injected in to the chamber and pumping it out. As the growth rate of ALD is a maximum of 10 nm/min, a thickness of only 500° A of TiO₂ is sufficient. Method 2: In between the films of these oxides or nitrides, an organic film such as polyimide can also be spin coated for relieving the stress of the resultant film. However, an ITO film needs to be deposited on polyimide film prior to the deposition of ALD film. Method (3): Since ALD is a slow process with minimum porosity known in the area of thin films the manufacturing process time will be long. Hence, the first ‘passivation’ film, directly in contact with OLED transparent electrode of ITO (shown in FIG. 3B), can be one of the oxides or nitrides films through ALD process to a thickness of around 250-500 A followed by plasma enhanced chemical vapor deposition (CVD) of Silicon nitride layer with high rate of deposition of 10-30 A/sec to a thickness of 1 micron. Method (4): An alternate stack of films is to deposit the first oxide or nitride film through ALD process, to a thickness of 250-500 A, on the ITO electrode of OLED and then deposit subsequent alternate layers of silicon oxide and nitride through plasma CVD process to a thickness of around 1 micron. Method (5): Still another method of film stack is to deposit the first thin film layer of one of the oxides or nitrides, mentioned above, through ALD to a thickness range of 250-500 A and then spin coat an organic-inorganic hard-coat solution such as Desolite 4D5-15 or Desolite 4D5-221 made by DSM Desotech Inc., on the ALD film that can be dried and UV cured to obtain a thickness of 2-5 micron. The thickness of the film can be optimized depending upon the transmission required and at the same time with minimum permeation of other solvents that come in to contact due to subsequent LCD process steps. Over the ‘passivation’ layer 303 is a counter electrode 304 of LCD made of ITO, through sputtering, followed by SiO₂ film 305 obtained through vacuum evaporation to a thickness of approximately 100 nm. A polarizing film 306 is coated by using TCF-N015 material of Optiva Inc through ‘doctor-blading’ or rod shearing technique to a thickness of 400 nm. A polyimide layer 307 is spin coated over the polarizing film to a thickness of 75 nm and surface treated for alignment of LC molecules. Top substrate of LCD 318 contains color filter layer 316 surrounded by black matrix 317. Over color filter layer 316 is deposited a ‘passivation’ layer 315, different from layer 303, that enables a good adhesion and conductivity for the subsequent ITO pixel electrode 313. For active matrix LCDs the ITO electrode 313 is connected to Thin Film Transistor (TFT) 314. SiO₂ film 312 to a thickness of 100 nm is vacuum evaporated on pixel electrode 313 followed by TCF-N015 layer 311 and polyimide layer 310, as on the bottom substrate 301.

FIG. 3B shows the layers of OLED 302 in detail. OLED serves as a continuous sheet source of backlight for the entire LCD. A reflective metal cathode around 300 nm made of Mg:Ag or any one of the metals or metal alloy of Li, Be, Na, Mg, K, Ca, Rb, Sr, Cs, Ba, Ce, La, Nd, Sm, In, LiAl, is vacuum evaporated on the bottom substrate of LCD followed by an organic layer 321, that functions as electron transport medium, through vacuum evaporation to a thickness of approximately 40 nm. This layer is followed by another organic layer called light generation layer 322 with or without doping, also vacuum deposited to a thickness of approximately 30 nm. Over the light generation layer are organic layers 323 and 324. Layer 323 is called hole-transport layer and layer 324 is called hole injection layer and both these layers are vacuum deposited to approximately 30 nm. Final layer is anode layer 325 which is usually transparent ITO that is sputtered on to the hole-injection layer 324. OLED process is a low temperature process involving predominantly vacuum evaporation process that is employed in small molecule OLED technology. However, other low temperature processes involving polymer OLED and phosphorescent OLED are equally compatible for processing the OLED device inside LCD. The light that is generated due to electron-hole recombination at the light generation layer 322 escapes through these transparent layers upward as depicted by 326. These are the rays that will backlight LCD.

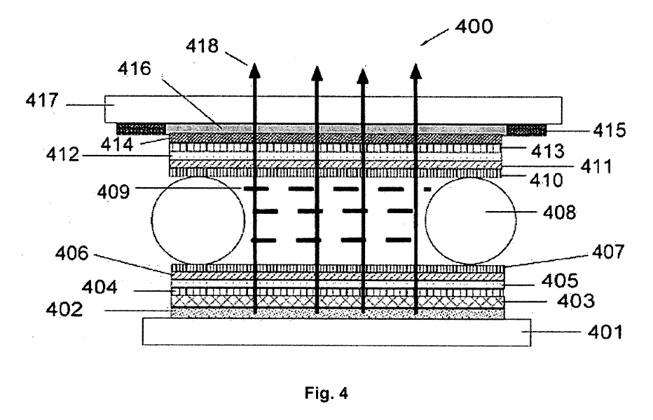

FIG. 4 is the cross section of single pixel configuration 400 of another embodiment of the present invention illustrating OLED sheet source of backlight inside a passive matrix liquid crystal display. OLED backlight device 402 is processed on the inside surface of bottom substrate 401 of LCD followed by a critical pin-hole free‘passivation’ layer 403 as described under FIG. 3A. Over this ‘passivation’ layer is sputtered a transparent conductive layer 404 of ITO that serves as one electrode of LCD. A SiO2 layer 405 an internal polarizing layer 406, using TCF-N015 of Optiva Inc, and polyimide liquid crystal alignment layer 407 are laid sequentially on ITO layer 404 as described under FIG. 3A. On the inside surface of the top substrate 417 of LCD, color filter layer 416 is coated with a surrounding black matrix layer 415. A ‘passivation’ layer 414, different from ‘passivation’ layer 403 on the bottom substrate, is deposited on the color filter layer for the subsequent ITO layer 413 to have a good adhesion and electrical conductivity to function as one of the electrodes of LCD. ITO layer 413, followed by SiO2 layer 412, polarizing layer 411 and alignment layer 410 are deposited in sequence as described in FIG. 3A. A liquid crystal film 409 with limiting spacers 408 is sandwiched between top substrate 417 and bottom substrate 401 of LCD. Light rays 418 from OLED emerge through all the layers when the LC pixel is optically open.

It will be apparent to those skilled in the art that various modifications and variations can be made in the construction, processing, configuration and/or operation and application of the present invention without departing from the scope or spirit of the invention. For example, in the embodiment described above in FIG. 3A TFT is located on the substrate containing color filter. This can be changed to have TFT on the substrate not containing the color filter. The illustration shown in FIG. 3A is for a Twisted Nematic (TN) LCD and hence LC alignment layers were coated on both substrates of LCD. For other modes of LCDs like the in-plane switching mode there may not be a need for alignment layer on both the substrates. Instead only one substrate needs to have LC alignment layer. There are other modes of LCD having only one polarizer. In the illustration shown in FIG. 3A there are two internal polarizing layers. This can be simplified to have only one polarizing layer on any one of the substrates. Similarly the illustration under FIG. 4 is for a passive matrix LCD in general. The LC molecules can have 90°, 180° or 270° twist or homogeneous orientation or homeotropic orientation. The structure is applicable for all passive matrix family of LCDs. The OLED device illustrated is a single OLED device. This device can be a series processed OLED device or series and parallel processed OLED device containing several OLEDs with different wavelengths. The description of OLED given above, is for small molecule technology. But it is equally applicable for polymer LED and phosphorescent OLED. Thus it is intended that the present invention covers the modifications and variations of the invention provided they come within the scope of the appended claims and their equivalents.

We claim:

1. An Organic Light Emitting Diode (OLED) backlight source inside Liquid Crystal Display (LCD) comprising:
an LCD and OLED between two substrates;
said two substrates having two surfaces each, of which inside surface of bottom substrate of LCD contains an up-emitting OLED;
said OLED comprises several layers starting with a reflective cathode layer on the inner surface of said bottom substrate of LCD, followed by electron transport layer, light emitting layer, hole transport layer, hole injection layer and a transparent anode layer;
said layers of OLED further followed by pin-hole free passivation layer, transparent conductive Indium Tin Oxide (ITO) layer for serving as one of the electrodes of LCD, SiO₂ layer, internal polarizing layer and an alignment layer for liquid crystal molecule;
said two substrates having two surfaces each, of which inside surface of top substrate of LCD contains color filter layer surrounded by black matrix layer, followed by a passivation layer, pixel ITO layer connected to Thin Film Transistor (TFT), SiO₂ layer, an internal polarizing layer and an alignment layer for liquid crystal molecules;
said liquid crystal molecules forming a twisted nematic structure and held in controlled thickness by spacers and all the said layers including liquid crystal molecules sandwiched between the said two substrates of LCD;
said LCD and OLED are processed in alignment and hermetically sealed between two substrates;
said LCD and said OLED inside said LCD applied with suitable voltages functioning as an active matrix full color LCD device with interior lighting from OLED that couples light efficiently to LCD.

2. An OLED backlight source inside LCD as claimed in claim 1 wherein OLED backlight contains multiplicity of OLEDs in series-parallel combination emitting wavelengths in visible region.

3. An OLED backlight source inside LCD as claimed in claim 1 wherein the OLED backlight is of small molecule OLED or of polymer LED or of phosphorescent OLED or hybrid of these.

4. An OLED backlight source inside LCD as claimed in claim 1 wherein the OLED is down emitting.

5. An OLED backlight source inside LCD as claimed in claim 1 where in the pin-hole free passivation layer over OLED is obtained through Atomic Layer Deposition (ALD) process or plasma assisted Chemical Vapor Deposition (CVD) process or sputtering process or vacuum evaporation process or spin coating process or combination of these processes.

6. An OLED backlight source inside LCD as claimed in claim 5 where in the material of the passivation layer is SiO₂, or Al₂O₃, or TiO₂, or Ta₂O₅, or Y₂O₃, or HfO₂, or Nb₂O₅, or MgO, or SiNₓ, or AlN in single layer or alternate layers of two films of different materials.

7. An OLED backlight source inside LCD as claimed in claim 6 where in organic films are formed in alternate layers of SiO₂, or Al₂O₃, or TiO₂, or Ta₂O₅, or Y₂O₃, or HfO₂, or Nb₂O₅, or MgO, or SiNₓ, or AlN or combinations of these materials.

8. An OLED backlight source inside LCD as claimed in claim 1 wherein the said internal polarizer comprises thin crystalline film of type TCF-N015 or an organic or inorganic layer that can polarize light.

9. An OLED backlight source inside LCD as claimed in claim 8 wherein the internal polarizer is on only one substrate of LCD that can operate with only one polarizer.

10. An OLED backlight source inside LCD as claimed in claim 8 wherein the said internal polarizer can be eliminated in LCD modes that do not require polarizer.

11. An OLED backlight source inside LCD as claimed in claim 1 wherein the said liquid crystal has a twist angle of 90° or 180° or 270°.

12. An OLED backlight source inside LCD as claimed in claim 1 wherein the said TFT is on the inside surface of the bottom substrate of LCD connecting ITO electrode.

13. An OLED backlight source inside LCD as claimed in claim 1 wherein the said LCD operates on Super Twist Nematic (STN) mode or Twisted Nematic (TN) mode or in-plane switching mode or multi-domain mode or guest-host mode or polymer dispersed mode or optically compensated bend mode or birefringence mode or scattering mode or vertically aligned mode or hybrid of these modes.

14. An OLED backlight source inside LCD comprising:
an LCD and OLED between two substrates;
said two substrates having two surfaces each, of which inside surface of bottom substrate of LCD contains an up-emitting OLED;
said OLED comprises several layers starting with a reflective cathode layer on the inner surface of said bottom substrate of LCD, followed by electron transport layer, light emitting layer, hole transport layer, hole injection layer and a transparent anode layer;
said layers of OLED further followed by pin-hole free passivation layer, transparent conductive Indium Tin Oxide (ITO) layer for serving as one of the electrodes of LCD, SiO₂ layer, internal polarizing layer and an alignment layer for liquid crystal molecule;
said two substrates having two surfaces each, of which inside surface of top substrate of LCD contains color filter layer surrounded by black matrix layer, followed by a passivation layer, I ITO layer, SiO₂ layer, an internal polarizing layer and an alignment layer for liquid crystal molecules;
said liquid crystal molecules forming a twisted nematic structure and held in controlled thickness by spacers and all the said layers including liquid crystal molecules sandwiched between the said two substrates of LCD;
said LCD and OLED are processed in alignment and hermetically sealed between two substrates;
said LCD and said OLED inside said LCD applied with suitable voltages functioning as a passive matrix full color LCD display device with interior lighting from OLED that couples light efficiently to LCD.

15. An OLED backlight source inside LCD as claimed in claim 14 wherein the internal polarizer is on only one substrate of LCD that can operate with only one polarizer.

16. An OLED backlight source inside LCD as claimed in claim 14 wherein the said internal polarizer can be eliminated in LCD modes that do not require polarizer.

17. An OLED backlight source inside LCD as claimed in claim 14 wherein the said liquid crystal has a twist angle of 90° or 180° or 270°.

18. An OLED backlight source inside LCD as claimed in claim 14 wherein the said LCD operates on Super Twist Nematic (STN) mode or Twisted Nematic (TN) mode or in-plane switching mode or multi-domain mode or guest-host mode or polymer dispersed mode or optically compensated bend mode or birefringence mode or scattering mode or vertically aligned mode or combinations of these modes.

19. An OLED backlight source inside LCD as claimed in claim 14 wherein the said OLED is down emitting.
